(19) United States
(12) Patent Application Publication
(10) Pub. No.: US 2007/0023977 A1
(43) Pub. Date: Feb. 1, 2007

(54) Substrate sheet for a 3d-shaping method

(76) Inventors: Stefan Braun, Renningen (DE); Bernd Hermann Renz, Marbach (DE)

Correspondence Address: Kriegsman & Kriegsman, 665 Franklin Street, Framingham, MA, 01702, US

(21) Appl. No.: 10/572,136

(22) PCT Filed: Sep. 10, 2004
(86) PCT No.: PCT/EP04/10150

§ 371 Date: Mar. 15, 2006

(30) Foreign Application Priority Data
Sep. 15, 2003 (DE) 103 42 880.1

(51) Int. Cl. B29C 35/08

(52) U.S. Cl. 264/497

(57) ABSTRACT

The invention relates to a substrate sheet for the application of at least one layer of a laying-up material (57), for the production of a three-dimensional moulded body (52), by the serial attachment of layers of a powder laying-up material (57), hardened by means of electromagnetic, or particle radiation in the positions corresponding to a cross-section of the moulded body (52) and provided for positioning on a support (43) in a process chamber (21, 24), whereby a mounting section (186) is provided with a mounting surface (188) for the mounting of layers and a support section (181) is provided which comprises a support surface (185), facing the support and with at least one recess (182), running from the support surface (185) of the support section (181), at least in a direction towards the mounting section (186).

The invention relates to a substrate sheet for the application of at least one first layer of a build-up material for the production of a three-dimensional molded body in accordance with the preamble of claim 1.

The present invention deals with generative manufacturing processes in which complex, three-dimensional components are built up in layers from material powders. The application areas for the invention include, in addition to rapid prototyping and the related disciplines of rapid tooling and rapid manufacturing, in particular the production of series tools and functional parts. These include, for example, injection molds with cooling passages close to the surface and also individual parts and small series of functional components for medical technology, mechanical engineering, aircraft and automotive construction.

The generative manufacturing processes which are of relevance to the present invention include laser fusion, which is known, for example, from DE 196 49 865 C1, in the name of Fraunhofer-Gesellschaft, and laser sintering, which is known, for example, from U.S. Pat. No. 4,863,538, in the name of the University of Texas.

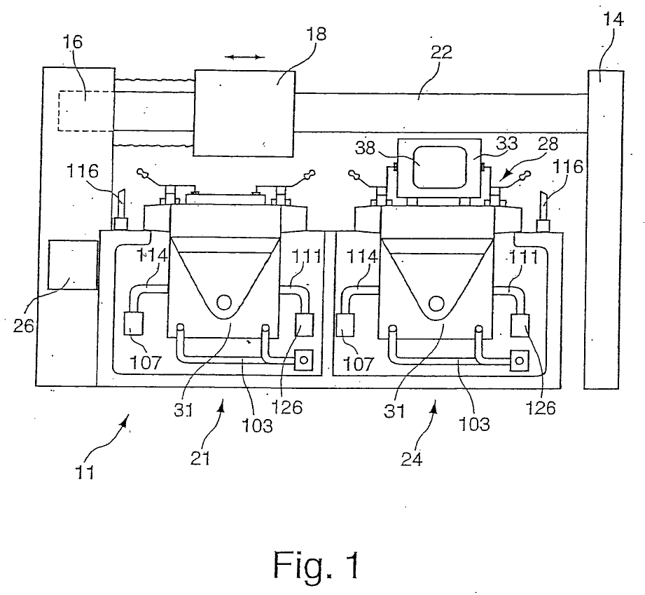

In the laser-melting process which is known from DE 196 49 865 C1, the components are produced from commercially available, single-component metallic material powders without binders or other additional components. For this purpose, the material powder is in each case applied as a thin layer to a building platform. This powder layer is locally fused using a laser beam in accordance with the desired component geometry. The energy of the laser beam is selected in such a way that the metallic material powder is completely fused over its entire layer thickness at the location of incidence of the laser beam. At the same time, a shielding gas atmosphere is maintained above the zone where the laser beam interacts with the metallic material powder, in order to avoid defects in the component which may be caused, for example, by oxidation. It is known to use a device shown in FIG. 1 of DE 196 49 865 C1 to carry out the process.

In the laser-sintering process which is known from U.S. Pat. No. 4,863,538, the components are produced from material powders which have been specially developed for laser sintering and which, in addition to the base material, contain one or more additional components. The different powder components differ in particular in terms of the melting point.

In the case of laser sintering, the material powder is applied to a building platform as a thin layer. This powder layer is locally irradiated with a laser beam in accordance with the geometry data of the component. The low-melting components of the material powder are fused by the laser energy which is introduced, while others remain in the solid state. The layer is secured to the previous layer by means of the fused powder components, which produce a bond on solidification. After a layer has been built up, the building platform is lowered by the thickness of one layer, and a new powder layer is applied from a storage vessel.

During the production of the molded body, for the stepwise application of the build-up material, a carrier is lowered stepwise in a process chamber. In order to minimize thermal stresses in the molded body to be produced, a substrate sheet arranged on the carrier is heated to a temperature of, for example, up to 500° C.

The temperature lag of the substrate sheet and thermal losses due to radiation and convection give rise to a temperature gradient over the thickness of the substrate sheet. This means that the substrate-sheet lower side, which directly faces the carrier, has a higher temperature than the upper side. This has the effect that a greater expansion in length of the lower side of the substrate sheet in comparison to the upper side is provided. In the heated state, a curvature is therefore formed over the substrate sheet, in particular in the case of round substrate sheets in the form of a hollow spherical segment. The substrate sheet then essentially rests at only one point in the center, and the transfer of heat from the carrier to the substrate sheet is reduced and can no longer be ensured.

If the thickness of the substrate sheet is reduced in order to solve the deformation problem, although the absolute difference in temperature between the upper side and the lower side of the substrate sheet is lower, the temperature gradient, by contrast, is steeper. This has the effect that the deformation is even greater. If the thickness of the substrate sheet is increased in order to solve the deformation problem, this does indeed have the advantage that the thicker substrate sheet warps to a lesser extent than a thin substrate sheet, but the disadvantage predominates that the absolute difference in temperature between the upper side and the lower side of the substrate sheet is substantially greater and that a very high force is required in order to keep the substrate sheet in contact with the carrier.

Therefore, the invention is based on the object of providing a substrate sheet in which a small difference in temperature between the lower side and the upper side of the substrate sheet is provided and small pull-down forces are required, in particular in the case of substrate sheets having a large surface area, in order to keep the substrate sheet in contact with the carrier.

This object is achieved according to the invention by the features of claim 1. Expedient developments and refinements of the invention are described in the dependent claims.

By means of the configuration according to the invention of the substrate sheet, which is divided into a supporting section facing the carrier and into a receiving section on the upper side of the substrate sheet, which receiving section serves to receive the molded body to be produced in a layered manner, the advantages of a thick and of a thin substrate sheet are attained and their respective disadvantages are compensated for. The supporting section comprises at least one depression which extends, at least in one direction, from a supporting surface of the supporting section as far as the receiving section of the substrate sheet. The at least one depression in the supporting section causes the distribution of temperature in the substrate sheet to be only slightly affected, so that essentially the distribution of temperature of a thick substrate sheet arises. This makes it possible for the thermal deformations to be smaller. The flexural rigidity is determined essentially only by the thickness of the receiving section. The substrate sheet thickness which is effective for the flexural rigidity is therefore determined by the distance between the base of the at least one depression and the receiving surface on the upper side of the substrate sheet. The at least one depression therefore means that smaller holding forces or pull-down are required in order to compensate for the thermally induced deformations. At the same time, the presence of at least one depression can prevent or considerably reduce warping of the substrate sheet.

The substrate sheet can be provided as such on the carrier or can be part of a pre-manufactured blank which is likewise arranged in the same manner as the substrate sheet as such on the carrier for the production of a three-dimensional molded body or for the completion of a three-dimensional molded body.

According to an advantageous refinement of the invention, it is provided that the substrate sheet has a supporting section, which is designed with depressions and faces the carrier, and a receiving section, the receiving section being designed to be thinner than the supporting section. The height of the depressions determines the thickness of the supporting section. By means of the depressions, the supporting section is interrupted and the effective thickness of the entire substrate sheet is reduced, with regard to the flexural rigidity of the substrate sheet, to the thickness of the receiving section, so that the pull-down forces are low. At the same time, the supporting section together with the receiving section forms a thick substrate sheet in partial regions, so that the temperature gradient is reduced and low deformation is obtained.

According to a further advantageous refinement of the invention, it is provided that a portion of the area of the supporting section which rests on the carrier is designed to be larger than the portion of the area of the depressions that faces the carrier. This ensures a sufficient transportation of heat from the carrier to the receiving section in order to heat up to the substrate sheet or a blank to an operating temperature of, for example, 300° C. to 500° C., thus enabling the molded body to build up in a manner low in internal stresses.

The depressions are advantageously designed as rectangular, semicircular, wedge-shaped, trapezoidal, circular-segment-shaped or polygonal cross sections. The cross-sectional geometry and also the size and the number of depressions depend on a material used for the substrate sheet, the dimensions, the machining temperature and on the properties of the shielding gas stream, such as, for example, thermal conductivity, flow speed and/or gas temperature. A geometry is preferably selected for the depressions and is introduced in the supporting section of the substrate sheet by turning or milling or by erosion.

The supporting section of the substrate sheet advantageously has depressions which run in a star-shaped manner with respect to its central point, are arranged concentrically with its central point, run in a rectilinear or curved manner, run parallel to one another, intersect or are arranged in a checkerboard pattern. Any desired combination of the abovementioned arrangement possibilities is advantageously also provided. The depressions may run in a plane along the substrate sheet or may be positioned at different heights or may have jumps in height. During the completion of special blanks or for the production of molded bodies which require a contour deviating from a planar supporting surface, the profiles of the depressions are matched in height, size and profile shape to the corresponding contours in order to obtain a uniformly distributed thermal expansion behavior over the entire substrate sheet.

In order to position and fix the position of the substrate sheet on the carrier, a holding device is preferably provided which is arranged in a position that continues to be maintained irrespective of thermal expansions of the substrate sheet. As a result, a uniform thermal expansion of the substrate sheet takes place during heating to the operating temperature, and stresses between the substrate sheet and the carrier as a consequence of uneven expansions in length are reduced or prevented. At the same time, during cooling of the substrate sheet after production of the molded body, forces directed in the same direction are effective with respect to the fixing point of the substrate sheet, from which fixing point the expansions in length take place during heating.

In order to orient and correctly position the substrate sheet, an orientation element is provided in the supporting section and acts on a complementarily formed orientation element of the carrier. These orientation elements can be designed, for example, as a positioning pin in an elongated hole, the arrangement of the elongated hole being provided either on the carrier or on the supporting section. The one orientation element, which is designed, for example, as a cutout or depression in the shape of an elongated hole, is advantageously oriented with respect to the holding device in such a manner that an expansion in length of the supporting section takes place without obstruction.

According to a preferred embodiment of the invention, the holding device is arranged in the center of gravity of the area of the substrate sheet. As a result, a largely homogeneous and uniform thermal expansion can take place in all of the directions of the substrate sheet, and the holding device is arranged in a neutral fixing point which is not changed or is virtually unchanged by the thermal expansion.

The holding device is preferably designed as releasable connection which is held with respect to the carrier by a latching or spring element in a manner such that it can be exchanged. This permits a rapid exchange of the substrate sheet or of the completed blank. The set-up times for a subsequent build-up process are reduced.

The holding device advantageously has a locking bolt which can be inserted into a mating element on the carrier. The spring or latching element acts to fix the holding device on the locking bolt, thus obtaining a pulling-down effect in order to bring the supporting section to bear on the carrier. At the same time, the substrate sheet is accurately oriented over a mating surface which is provided on the locking bolt and interacts with the mating element.

According to a further advantageous embodiment of the invention, it is provided that at least one securing element acts on the outer edge region of the supporting section and holds down the outer edge region of the supporting section with respect to the carrier. These securing elements are preferably provided in the case of substrate sheets having relatively large dimensions, in particular having a relatively large external diameter, in order to prevent the substrate sheet warping. These securing elements may be provided in addition to the holding device, with, for example in the case of round substrate sheets, the holding device being provided in the central point and the securing elements being distributed radially over the periphery in the outer edge region. As an alternative, provision may also be made for only the securing elements to be distributed over the periphery in the outer edge region without a holding device being provided.

The securing elements are preferably designed as pull-down threads which are accessible from the upper side of the substrate sheet. This enables access to be provided to the securing element from the outside in order to fix the substrate sheet with respect to the carrier. The securing elements for their part are positioned within the carrier. The securing elements are advantageously designed in such a manner that, after screwing down together with the substrate sheet, they form a completely closed receiving section.

The securing elements are preferably held in a spring-mounted manner in the carrier. The edge region of the supporting section is therefore held down under spring force in order to make it possible for the supporting section to bear securely on the carrier irrespective of the temperature. At the same time, a radial play for receiving the securing elements is advantageously provided, so that thermal expansions in the carrier and in the substrate sheet can take place unobstructed by one another.

In order to increase the degree of automation, it is advantageously provided that the securing elements have a stem which passes through the carrier and is accessible on a lower side of the carrier for an actuating device. As a result, the securing elements can be actuated by handling devices, with only a slight restriction of the construction space being incurred.

According to an alternative refinement of the invention, the holding device is designed as a clamping element which preferably has a draw-in collet, a wing rod, a hollow conical stem or a threaded rod which passes through the carrier and is accessible on a lower side of the carrier via an actuating device. The refinement of a tension rod arrangement has the advantage that a defined clamping force with self-locking is applied in the event of a failure of power. It is readily able to be automated. The embodiment of a wing rod furthermore has the advantage that the clamping elements do not become worn. The refinement of a holding device according to the hollow conical stem principle has the advantage that low demands in terms of manufacturing are made of the clamping bolt and there is self-locking.

According to a further alternative refinement of the invention, it is provided that the securing elements are designed as a rapid clamping device, for example as a helical groove clamping element, and are preferably accessible from the upper side of the substrate sheet. By means of the securing elements, the clamping distance can be limited and a defined clamping force for holding down the substrate sheet with respect to the carrier can be obtained.

The abovementioned embodiments of the holding devices and securing elements can be provided individually or in any desired combination with one another in order to position and fix the substrate sheet or a premanufactured blank with respect to the carrier.

The invention and further advantageous embodiments and developments thereof are described and explained in more detail below with reference to the examples illustrated in the drawings. According to the invention, the features revealed in the description and the drawings can be employed individually on their own or in any desired combination. In the drawings:

FIG. 1 shows a diagrammatic side view of a device according to the invention,

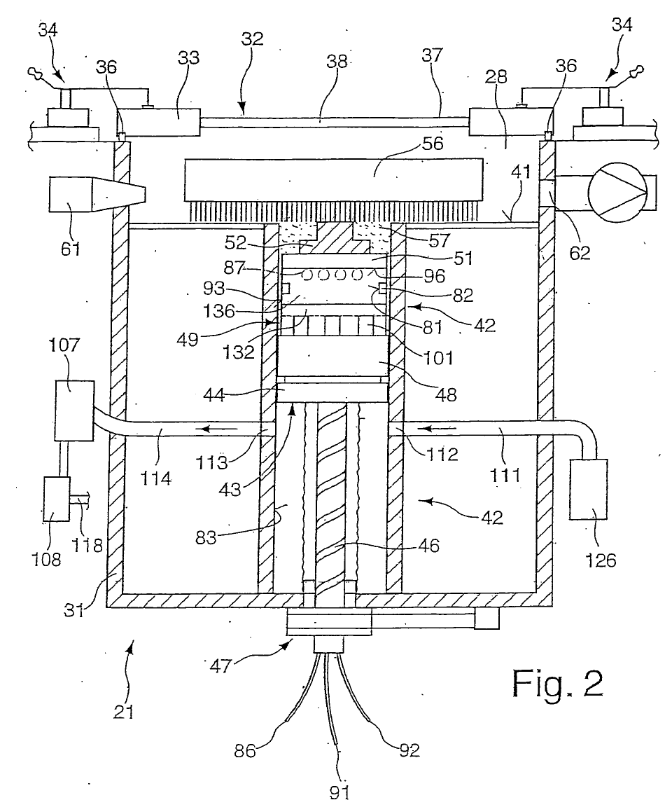

FIG. 2 shows a diagrammatic sectional illustration of a process chamber in a machining position during the layered build-up of a molded body,

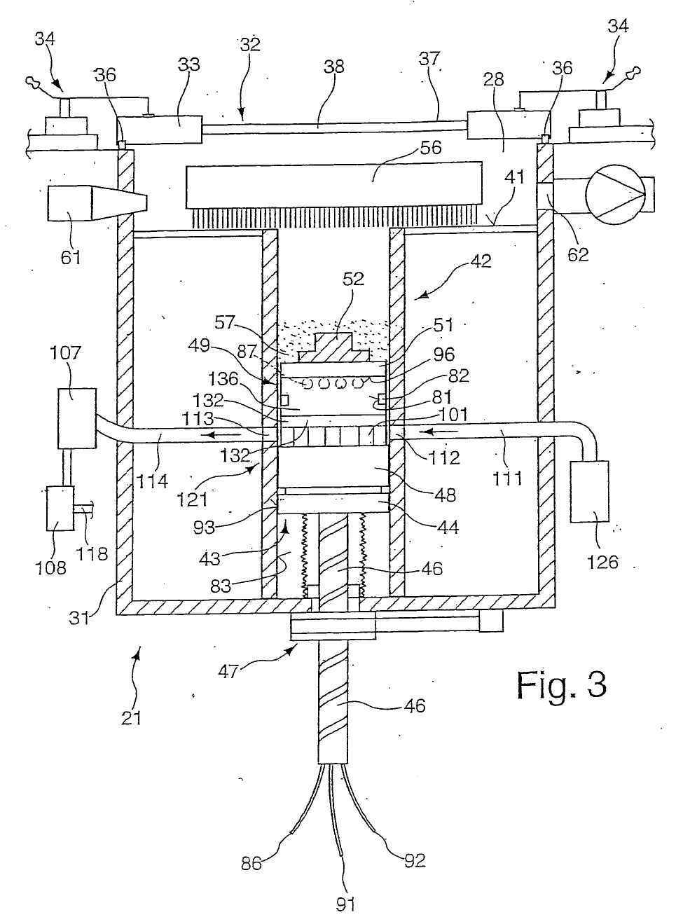

FIG. 3 shows a diagrammatic sectional illustration of the process chamber shown in FIG. 2 after layered build-up of a molded body, in a cooling position,

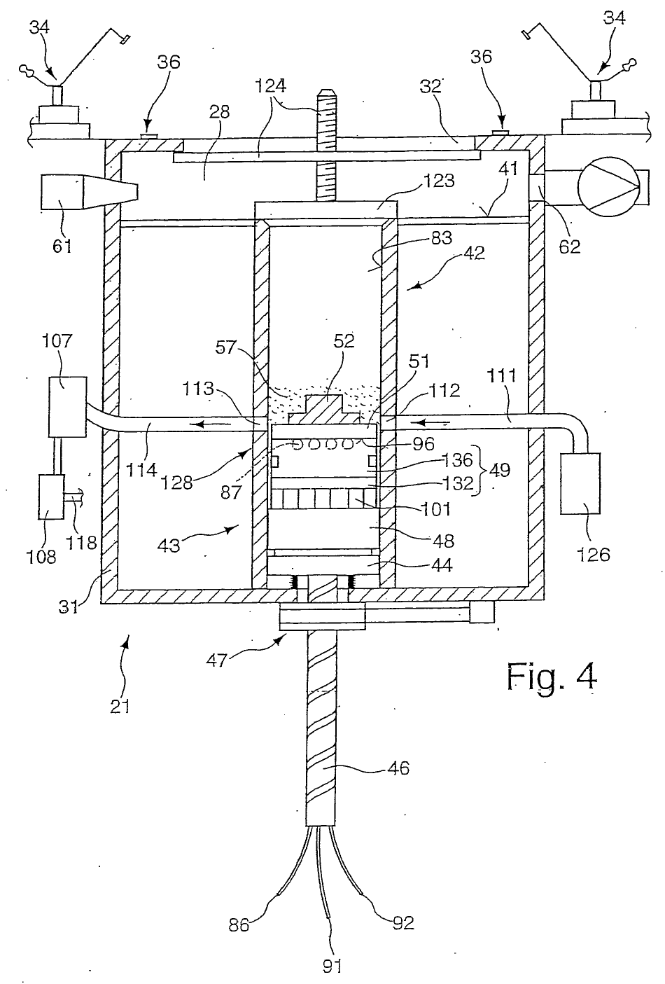

FIG. 4 shows a diagrammatic sectional illustration of the process chamber shown in FIG. 2 after layered build-up of a molded body, in a suction position,

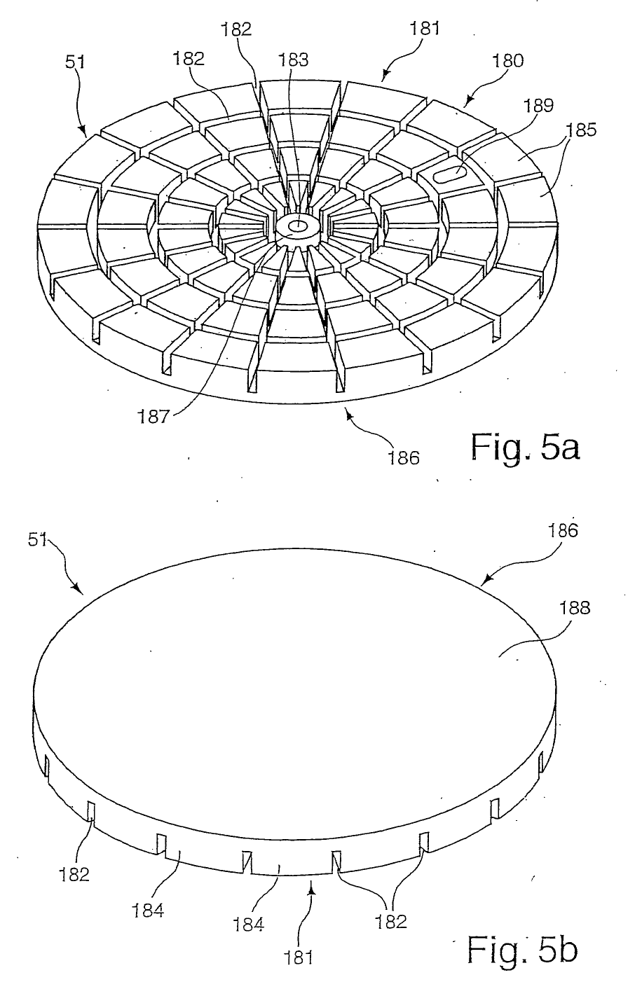

FIGS. 5a and b show a perspective view of a substrate sheet according to the invention,

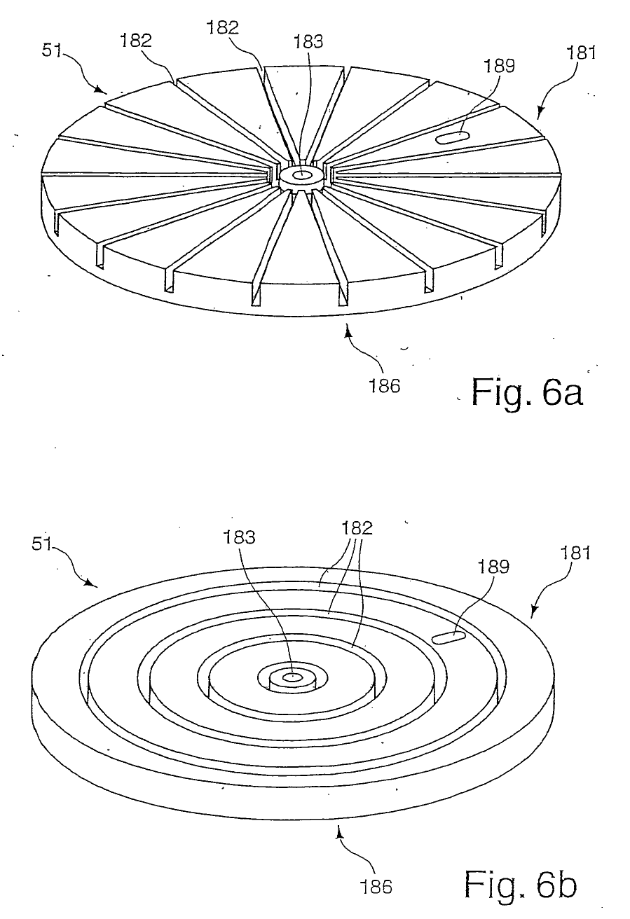

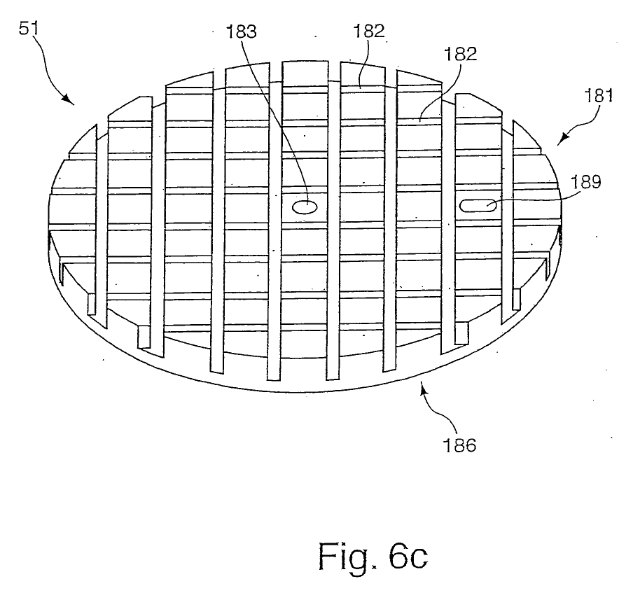

FIGS. 6a to c show a diagrammatic illustration of alternative embodiments of the substrate sheet according to the invention according to FIGS. 5a and b,

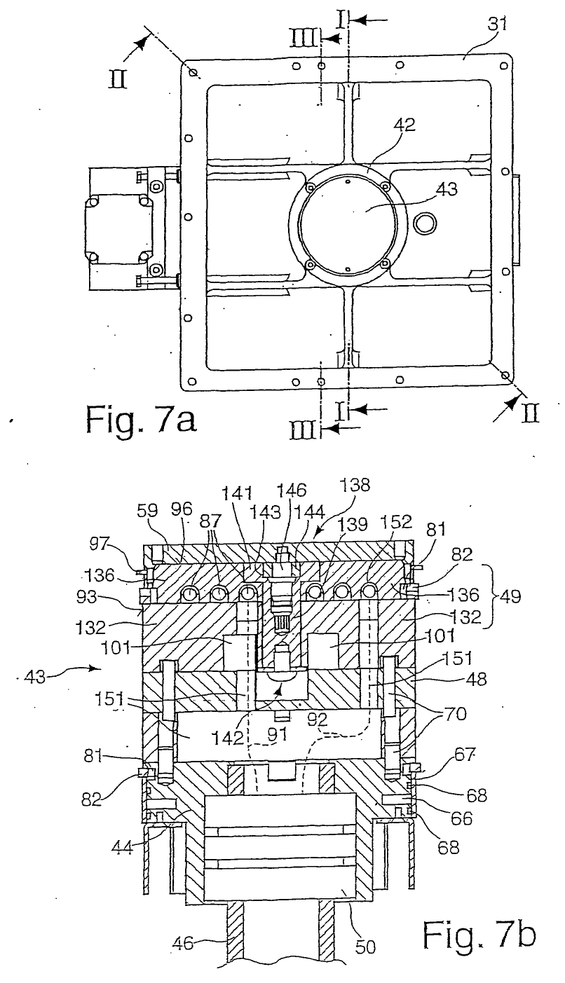

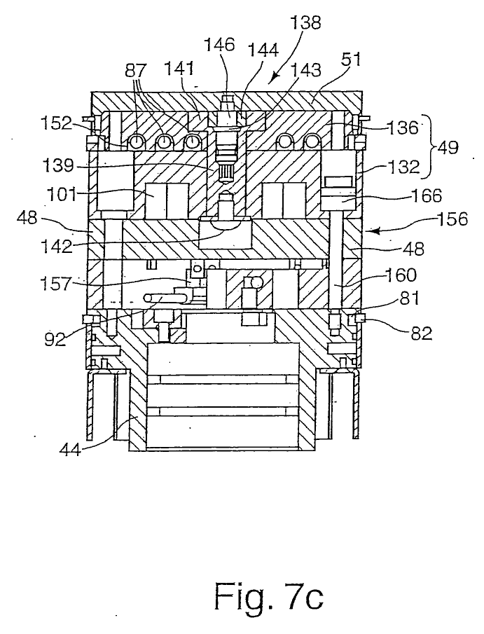

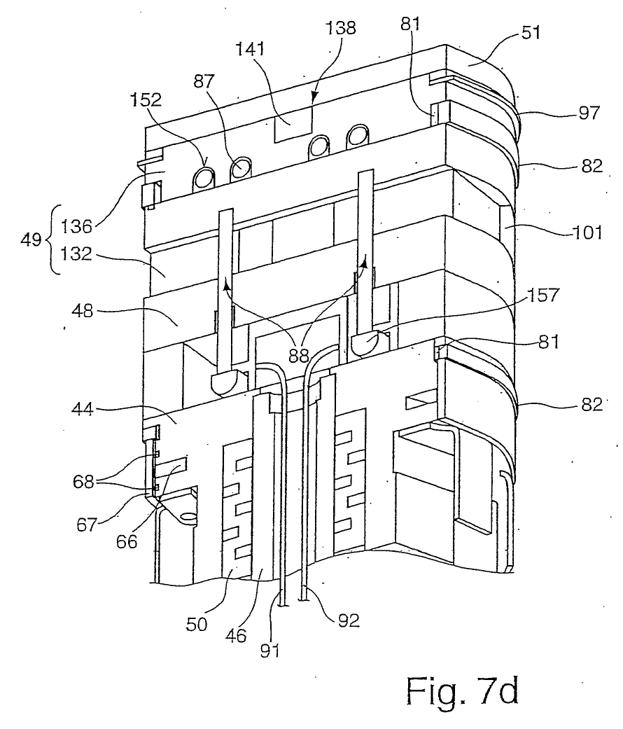

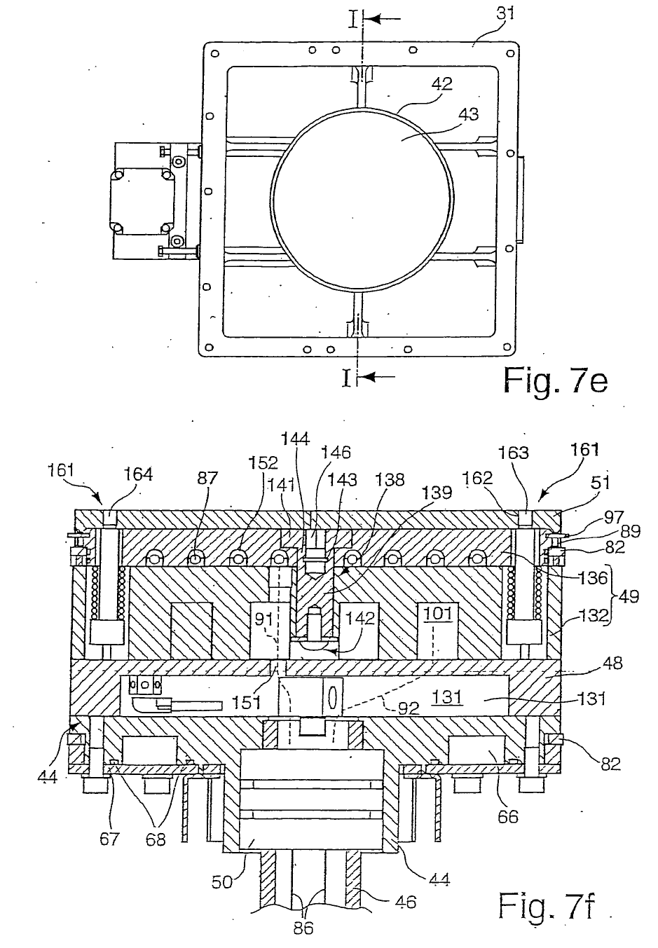

FIG. 7a shows a diagrammatic plan view of a first embodiment of a carrier with a substrate sheet in a build-up chamber,

FIG. 7b shows a diagrammatic sectional illustration along the line I-I in FIG. 7a,

FIG. 7c shows a diagrammatic sectional illustration along the line II-II in FIG. 7a,

FIG. 7d shows a diagrammatic sectional illustration along the line III-III in FIG. 7a,

FIG. 7e shows a diagrammatic plan view of a second embodiment of a carrier with a substrate sheet in a build-up chamber,

FIG. 7f shows a diagrammatic sectional illustration along the line I-I in FIG. 7e.

FIG. 1 diagrammatically depicts a device 11 according to the invention for the production of a three-dimensional molded body by successive consolidation of layers of a pulverulent build-up material. The production of a molded body by laser fusion is described, for example, in DE 196 49 865 C1. The device 11 comprises a beam source 16, which is arranged in a machine frame 14, in the form of a laser, for example a solid-state laser, which emits a directed beam. This beam is focused via a beam-diverter device 18, for example in the form of one or more actuable mirrors, as a diverted beam onto a working plane in a process chamber 21. The beam-diverter device 18 is arranged such that it can be displaced by motor means along a linear guide 22 between a first process chamber 21 and a further process chamber 24. The beam-diverter device 18 can be moved into a precise position with respect to the process chambers 21, 24 by means of actuating drives. Furthermore, the machine frame 14 provides a control and arithmetic unit 26 for operation of the device 11 and for setting individual parameters for the working processes used to produce the molded bodies.

The first process chamber 21 and at least one further process chamber 24 are arranged separately from one another and are hermetically isolated from one another.

FIG. 2 illustrates the process chamber 21, by way of example, fully in cross section. The process chamber 21 comprises a housing 31 and is accessible through an opening 32 which can be closed off by at least one closure element 33. The closure element 33 is preferably designed as a pivotable cover which can be fixed in a closed position by locking elements 34, such as for example toggle lever elements. A seal 36, which is preferably formed as an elastomer seal, is provided at the housing 31, close to the opening 32, to seal off the process chamber 21. The closure element 33 has a region 37 which transmits the electromagnetic radiation of the laser beam. It is preferable to use a window 38 made from glass or quartz glass which has anti-reflection coatings on the top side and the underside. The closure element 33 may preferably be of water-cooled design.

The process chamber 21 comprises a base surface 41. A build-up chamber 42, in which a carrier 43 is provided and guided such that it can move up and down, opens out into this base surface 41 from below. The carrier 43 comprises at least one base plate 44, which is driven such that it can be moved up and down by means of a lifting rod or lifting spindle 46. For this purpose, a drive 47, for example a toothed belt drive, is provided to move the fixed lifting spindle 46 up and down. The base plate 44 of the carrier 43 is preferably cooled by a fluid medium, which preferably flows through cooling passages in the base plate 44, at least during the layered build-up. An insulation layer 48 made from a mechanically stable, thermally insulating material is arranged between the base plate 44 and the building platform 49 of the carrier 43. This prevents the lifting spindle 46 from being heated by the heating of the building platform 49, with an associated effect on the positioning of the carrier 43.

An application and leveling device 56, which applies a build-up material 57 into the build-up chamber 42, moves along the base surface 41 of the process chamber 21. A layer is built up on the molded body 52 by selective fusion of the build-up material 57.

The build-up material 57 preferably comprises metal or ceramic powder. Other materials which are suitable and used for laser fusion and laser sintering are also employed. The individual material powders are selected as a function of the molded body 52 to be produced.

On one side, the process chamber 21 has an inlet nozzle 61 for the supply of shielding gas or inert gas. At an opposite side, there is an extraction nozzle or extraction opening 62 for removing the supplied shielding or inert gas. During production of the molded body 52, a laminar flow of shielding or inert gas is generated, in order to avoid oxidation during fusion of the build-up material 57 and to protect the window 38 in the closure element 33. It is preferable for the hermetically locked process chamber 21 to be held at a superatmospheric pressure of, for example, 20 hPa during the build-up process, although significantly higher pressures are also conceivable. This means that it is impossible for any atmospheric oxygen to penetrate into the process chamber 21 from the outside during the build-up process. During circulation of the shielding or inert gas, it is simultaneously also possible to realize cooling. It is preferable for cooling and filtering of the shielding or inert gas to remove entrained particles of the build-up material 57 to be provided outside the process chamber 21.

The build-up chamber 42 is preferably of cylindrical design. Further geometries may also be provided. The carrier 43 or at least parts of the carrier 43 are matched to the geometry of the build-up chamber 42. In the build-up chamber 42, the carrier 43 is moved downwards with respect to the base surface 41 in order to effect a layered build-up. The height of the build-up chamber 42 is matched to the build-up height or the maximum height to be built up for a molded body 52.

A peripheral wall 83 of the build-up chamber 42 directly adjoins the base surface 41 and extends downwards, this peripheral wall 83 being suspended from the base surface 41. At least one inlet opening 112 is provided in the peripheral wall 83. This inlet opening 112 is in communication with a feed line 111 which accommodates a filter 126 outside the housing 31. Ambient air is fed to the build-up chamber 42 through the inlet opening 112 via the filter 126 and the supply line 111. Furthermore, the build-up chamber 42 has at least one outlet opening 113 in the peripheral wall 83, to which outlet opening there is connected a discharge line 114 which leads out of the housing 31 and opens out into a separation device 107. Downstream of the latter there is a filter 108 which discharges the volumetric flow that has been discharged from the build-up chamber 42 via a connecting line 118. It is advantageously provided that the inlet opening 112 and the outlet opening 113 are aligned with one another. It is also possible for the openings 112, 113 to be arranged offset with respect to one another, both in terms of the height and in terms of their feed position in the radial direction or at right angles to the longitudinal axis of the build-up chamber 42.

The building platform 49 is composed of a heating plate 136 and a cooling plate 132. Heating elements 87 are illustrated by dashed lines in the heating plate 136. Furthermore, the heating plate 136 comprises a temperature sensor (not shown in more detail). The heating elements 87 and the temperature sensor are connected to supply lines 91, 92, which in turn are routed through the lifting spindle 46 to the building platform 49. A peripheral groove 81, in which one or more sealing rings 82 are fitted, is provided at the external periphery 93 of the building platform 49; the diameter of the sealing ring(s) 82 can be altered slightly and matched to the installation situation and temperature fluctuations. The sealing ring(s) 82 bear(s) against a peripheral wall 83 of the build-up chamber 42. This sealing ring 82 has a surface hardness which is lower than that of the peripheral wall 83. The peripheral wall 83 advantageously has a surface hardness which is greater than the hardness of the build-up material 57 provided for the molded body 52. This makes it possible to ensure that there is no damage to the peripheral wall 83 during prolonged use, and only the sealing ring 82, as a wearing part, has to be replaced at maintenance intervals. It is advantageous for the peripheral wall 83 of the build-up chamber 42 to be surface-coated, for example chromium-plated.

The base plate 44 comprises a water cooling system which is in operation at least while the molded body 52 is being built up. Cooling liquid is fed to the cooling passages provided in the base plate 44 via a cooling line 86 which is fed to the base plate 44 through the lifting spindle 46. The cooling medium provided is preferably water. The cooling allows the base plate 44 to be set, for example, to a substantially constant temperature of 20° C. to 40° C.

To receive a molded body 52, the carrier 43 has a substrate plate 51 which is positioned fixedly or releasably on the carrier 43 by means of a retaining means and/or an orientation aid. Before production of a molded body 52 commences, the heating plate 136 is heated to an operating temperature of between 300° C. and 500° C., in order to allow the molded body 52 to be built up with low stresses and without cracks. The temperature sensor (not shown in more detail) records the heating temperature or operating temperature while the molded body 52 is being built up.

The building platform 49 has cooling passages 101, which preferably extend transversely throughout the entire building platform 49. It is possible to provide one or more cooling passages 101. The position of the cooling passages 101 is, for example, illustrated adjacent to the insulating layer 48 in accordance with the exemplary embodiment. Alternatively, it is possible for the cooling passages 101 to extend not just beneath heating elements 87 but also above and/or between the heating elements 87.

After completion of the molded body 52, the carrier 43 is lowered from the position illustrated in FIG. 2 into a first position or cooling position 121. This position is illustrated in FIG. 3. Even while the carrier 43 is being lowered, a volumetric flow from the environment can be fed via the filter 126 and the supply line 111 to the build-up chamber 42 and discharged from the build-up chamber 42 via the outlet opening 113 and discharge line 114. The build-up chamber 42 can be cooled as early as at this stage and also while the molded body 52 is being built up.

The cooling position 121 of the carrier 43 is provided in such a manner that cooling passages 101 of the building platform 49 are aligned with the at least one inlet opening 112 and at least one outlet opening 113 in the peripheral wall 83 of the build-up chamber 42. The volumetric flow flows through the cooling passages 101, thereby cooling at least the building platform 49. The cooling may be effected by a pulsed suction stream. The cooling rate in the molded body 52 can be determined by the pulse/pause ratio. It is preferable to provide for uniform cooling for a predetermined period of time, to minimize the build-up of internal stresses in the molded body 52. The cooling may also be provided by a volumetric flow which continuously increases or decreases in quantitative terms. It is also possible to alternate between an increase and a decrease in order to obtain the desired cooling rate. The cooling rate can be recorded by the temperature sensor provided in the heating plate 136. At the same time, the residual temperature of the molded body 52 can be derived via this temperature sensor. This cooling position 121 is maintained until the molded body 52 has been cooled to a temperature of, for example, less than 50° C. At the same time, the base plate 44 can be cooled further in this cooling position 121. In addition, it is also possible to provide for cooling passages or cooling hoses to be provided adjacent to the peripheral wall 83 of the build-up chamber 42 or in the peripheral wall 83 of the build-up chamber 42, these cooling passages or cooling hoses also contributing to cooling of the build-up chamber 42, the molded body 52 and the carrier 43.

After the molded body 52 has been cooled to the desired or preset temperature, the carrier 43 is transferred into a further position or suction position 128, which is illustrated in FIG. 4. This suction position 128, which is illustrated by way of example, is used to remove, in particular suck out, the build-up material 57 which has not been consolidated during production of the molded body 52. The build-up chamber 42 is closed by a closure element 123 prior to the application of a suction stream flowing through the build-up chamber 42. This closure element 123 has securing elements 124 which act on or in the opening 32 in order to fix the closure element 123 tightly to the build-up chamber 42. The closure element 123 is preferably of transparent design, so that it is possible to monitor the sucking-out of build-up material 57 that has not been consolidated. A suction stream flowing through the build-up chamber 42 generates a swirl in the build-up chamber 42, with the result that the build-up material 57 that has not been consolidated is sucked out and fed to the separation device 107 and the filter 108. At the same time, furthermore, the suction is responsible for cooling the build-up chamber 42, the molded body 52 and the building platform 49. In addition, it is possible to effect a further supply of air via at least one nozzle in the closure element 123.

The sucking-out of the build-up material 57 can be operated by a constant volumetric flow, a pulsed volumetric flow or a volumetric flow with an increasing or decreasing mass throughput. The suction is terminated after a predetermined duration of the suction or after a period of time which can be set by the operating personnel.

To remove the molded body 52, the closure element 123 is removed from the build-up chamber 42 and the carrier 43 moves into an upper position, so that the molded body 52 is positioned at least partially above the base surface 41 of the process chamber 21 in order to be removed.

FIGS. 5a and b illustrate a plan view of the lower side (FIG. 5a) and the upper side (FIG. 5b) of a substrate sheet 51 according to the invention. According to the exemplary embodiment, the substrate sheet 51 is designed as a round, plate-like body. The geometry of the substrate sheet 51 can be matched to the geometry of the build-up chamber 42, so that the substrate sheet 51 extends as far as the peripheral wall 83 of the build-up chamber 42. As an alternative, provision may be made for the geometry of the substrate sheet 51 to correspond to the geometry of the molded body 52 and for a corresponding supplementary sheet to be provided in order to bridge regions from the outer contour of the substrate sheet 51 as far as the peripheral wall 83 of the build-up chamber 42.

The view according to FIG. 5a shows a lower side or a supporting section 181 of a substrate sheet 51 with a supporting surface 185 which rests on the carrier 43. The supporting section 181 has depressions 182 which, according to the exemplary embodiment, are provided by grooves of rectangular design. These depressions 182 are oriented in a star-shaped manner with respect to the central point 183 of the substrate sheet 51. Furthermore, further depressions 182 are provided concentrically with the central point 183, as a result of which the pattern illustrated in FIG. 5a is produced and the supporting surface 185 is determined. The depressions 182 which are oriented in a star-shaped manner and run in a rectilinear manner are advantageously milled into place. The depressions 182 running concentrically with the central point 183 are preferably produced by turning. As an alternative, it may also be provided that such configurations of a supporting section 181 are also produced by casting, stamping, pressing or the like.

The supporting section 181 is provided with an orientation element 189 which is designed in the form of an elongated hole or a depression in the shape of an elongated hole. A complementary orientation element 147 which is designed, for example, as a positioning pin engages in this elongated hole. The orientation of the orientation element 189 with respect to the central point 183 is provided in such a manner that, when the substrate sheet 51 is heated, a stress-free thermal expansion is made possible. A receiving hole 187 which is designed to receive a holding device 138 is illustrated in the central point 183.

The view according to FIG. 5b shows the upper side of the substrate sheet according to the invention as shown in FIG. 5a. In addition to the supporting section 181, the substrate sheet 51 comprises a receiving section 186 with a receiving surface 188 which forms the upper side of the substrate sheet 51 on which the molded body 52 is built up in a layered manner. Next to the depressions 182, the supporting section 181 has zones 184 which are bounded by the depressions 182. In the region of the depressions 182, the base or the bottom of the depression 182 forms the transition region to the receiving section 186 which is illustrated by dashed lines in FIG. 5b.

The depth of the depressions 182 determines the thickness of the supporting section 181 which merges smoothly into the receiving section 186 in the region of the zones 184. Since the thickness of the receiving section 186 is designed to be smaller than the thickness of the supporting section 181, the substrate sheet 51 comprises a thin and a thick plate-like body. The distribution of temperature in the supporting section 181 is only slightly affected by the depressions 182, so that, furthermore, the distribution of temperature of a thick substrate sheet is present, and warping of the substrate sheet and thermal deformations are considerably reduced. The depressions 182 in the supporting section 181 reduce the thickness effective for the flexural rigidity to the thickness of the receiving section 186, so that smaller holding forces or pull-down forces are required in order to compensate for the deformations thermally induced by the carrier. As a result, the advantages according to the invention are obtained.

FIG. 6a illustrates a further alternative embodiment of a supporting section 181 of the substrate sheet. This embodiment has depressions 182 exclusively running in a star-shaped manner with respect to the central point 183. The number of depressions 182 and the width thereof and cross-sectional profile thereof is matched to the dimensions of the substrate sheet 51, the material of the substrate sheet 51 and also to the machining temperature during the layered build-up of a molded body.

FIG. 6b illustrates a further alternative refinement of a supporting section 181, in which the depressions 182 are provided exclusively concentrically with the central point 183 of the substrate sheet. This embodiment also has the advantages of a thin plate-like body combined with a thick plate-like body.

FIG. 6c illustrates a further alternative embodiment of a supporting section 181 of a substrate sheet 51. Depressions 182 running in a rectilinear manner and intersecting form a checkerboard pattern. The depressions 182 which are arranged rectilinearly and parallel to one another may also intersect at any desired angles with respect to one another. A regular arrangement of the depressions 182 is advantageously provided in order to obtain uniform thermal expansions and thermal distributions. These regular arrangements may also be formed in a point-symmetric manner with respect to the central point 183, in particular in the case of round substrate sheets 51.

The embodiments according to FIGS. 5a, b, 6a to cshow the arrangement of an orientation element 189 in the zones 184 between the depressions 182, so that the depressions 182 have a free passage.

FIG. 7a illustrates a diagrammatic plan view of a carrier 43 in a build-up chamber 42. The build-up chamber 42 is positioned in the housing 31 of the process chambers 21, 24. By means of the sections illustrated in FIG. 7a, the build-up of the carrier 43 and the reception and arrangement of the substrate sheet 51 on the carrier 43 are described in more detail below with reference to FIGS. 7a to 7d.

The first preferred embodiment relates to a carrier 43 which is provided for receiving a substrate sheet 51 which is designed to be smaller in diameter in relation to the embodiment below according to FIGS. 7e to 7f. The section according to FIG. 7b shows a carrier 43 with a base plate 44 which is positioned on a lifting spindle 46. For the connection between the base plate 44 and the lifting spindle 46, a clamping element 50 is provided and is positioned between the two elements 44, 46. The base plate 44 has a water cooling system which is in operation at least while the molded body 52 is being built up. This water cooling system is formed, for example, by a cooling water groove 66. This cooling water groove 66 is cut in from the outside and is closed by a closure element 67, for example a sleeve, with a respective sealing element 68 being provided adjacent to the cooling water groove 66 in order to provide a leakproof arrangement of the closure element 67 with respect to the water cooling groove 66. The cooling water groove 66 is, for example, not provided with a solid periphery, but rather is interrupted in the periphery, so that a controlled feeding in of cooling liquid is made possible at one end and a specific discharge of the heated cooling liquid is made possible at the other end of the water cooling groove 66. The cooling allows the base plate 44 to be set during production of the molded body, for example, to a substantially constant temperature of 20° C. to 40° C. Water is preferably provided as the cooling medium, with it being possible for any further cooling liquid, cooling emulsion, cooling oils or the like to be provided.

An insulating layer 48 is provided between the base plate 44 and a building platform 49. This insulating layer 48 advantageously has low thermal conductivity and a high compressive strength and serves as a thermal separation between the building platform 49 and the base plate 44.

The building platform 49 comprises a cooling plate 132 and a heating plate 136 which are connected to each other by a holding device 138. A mating element 139 is inserted into a central hole of the cooling plate 132, said mating element having a peripheral collar 141 at the other end in order to position the heating plate 136 with respect to the cooling plate 132. At the lower end of the mating element 139, a releasable securing means 142 is provided, by means of which the mating element 139 or the heating plate 136 is fixed releasably with respect to the cooling plate 132. In the mating element 139, a latching or spring element 143 is inserted into a hole and is fixed in the mating element 139 by means of a fastening screw 144.

This refinement of the mating element 139 provides a rapidly exchangeable receptacle for a substrate sheet 51, which has, on its lower side, a locking bolt 146 which is inserted into the hole of the mating element 139. In a fitted position according to FIG. 7b, the latching spring element 143, which is designed as an annular spring, latches in place at a peripheral depression of the locking bolt 146 and fixes the substrate sheet 51 in a manner such that it fits snugly with respect to the heating plate 136. A positioning pin 147 can be provided for the correct positioning of and as a means of securing against rotation for the substrate sheet 51 in relation to the heating plate 136.

The building platform 49 is oriented and correctly positioned for insulation by means of cylindrical pins 70. In addition, passages 151 are provided via which supply lines 91, 92 can be fed through the lifting spindle 46 to the heating plate 136 and can be removed again from the latter. The heating plate 136 comprises heating elements 87, for example tubular heating bodies, which are arranged in the recesses 152. As an alternative, heating wires or further heating media can also be provided and make it possible for the heating plate 136 to be able to heat up to a temperature of, for example, 300° C. to 500° C. while the molded body 52 is being built up, in order to allow the molded body 52 to be built up with low stresses and without cracks.

At the external periphery 93, adjacent to the cooling plate 132, the heating plate 136 has a seal 82 which is provided in a groove 81. For example, two seals 82 which are backed by annular springs are provided in the upper region. Furthermore, as an alternative other sealing elements 82 can be provided which guide the carrier 43 in the build-up chamber 42. A stripping element 97 which is preferably formed from a felt ring is provided adjacent to or immediately below an upper end surface 96 of the heating plate 136. This refinement makes it possible for a leakproof arrangement to be provided in spite of the different expansions of the heating plate 136 and of the peripheral wall 83 of the build-up chamber 42. In addition, a penetration of the build-up material 57 between the carrier 43 and the peripheral wall 83 of the build-up chamber 42 can be prevented by the stripping element or elements 97.

Cooling passages 101 which pass completely through the cooling plate 132 are provided in the cooling plate 132. For example, two cooling passages 101 with a square or rectangular cross section are provided which run parallel to each other and are also provided crosswise with respect to each other. The configuration and arrangement of the cooling passages 101 is as desired. It is possible for a plurality of cooling passages 101 to be provided which can be arranged crosswise with respect to one another. It is likewise possible for one or more cooling passages 101 to be provided which are distributed over the periphery in uniform or nonuniform angular sections and form a type of spoke-like configuration. The number, geometry, size of the cross section and the flow path of the cooling passages 101 is matched to the cooling system used and its connections which are provided on the build-up chamber 42.

FIG. 7c illustrates a diagrammatic sectional illustration along the line II-II in FIG. 7a. This sectional illustration reveals, by way of example, a means of securing by means of a screw connection 156 of the cooling plate 132 with the interconnection of the insulating layer 48. A securing element 160 receives a length compensation element 166, so that changes in length caused by changes in temperature and therefore stresses which occur can be compensated for. The layered build-up of the carrier 43, which, according to this embodiment, comprises a base plate 44, an insulating layer 48, a cooling plate 132 and a heating plate 136, is thus constructed and positioned with respect to one another by means of releasable screw connections. A positionally correct orientation takes place by, for example, the cylindrical pins 70 (FIG. 7b). The cylindrical pins 70 pass completely through the insulating layer 48, so that the cooling plate 132 has a certain orientation with respect to the base plate 44.

FIG. 7d illustrates a further diagrammatic sectional illustration along the line III-III according to FIG. 7a. This sectional illustration reveals the arrangement of temperature sensors 88 which are positioned within the cooling plate 132 next to the heating plate 136 or in the transition region. These temperature sensors 88 detect the heating temperature or operating temperature while the molded body 52 is being built up. These temperature sensors 88 can also detect a cooling of the heating plate 136 by the cooling of the cooling plate 132 via the cooling passages 101. The cooling speed or the cooling rate for the completed molded body 52 can be determined and controlled therefrom. The arrangement of the temperature sensors 88 is only by way of example. Their supply lines 92 are fed in and removed via the lifting spindle 46 analogously to the supply lines 91 of the heating elements 87. A connection 157 for the temperature sensors is illustrated in FIG. 7c.

FIG. 7e illustrates a schematic plan view of a carrier 43 analogously to FIG. 7a. The sectional illustration illustrated in FIG. 7f shows an alternative embodiment according to the invention to a carrier 43 according to FIGS. 7a to 7e, with the embodiment of a carrier 43 that is illustrated in FIGS. 7e to 7f being particularly suitable for receiving substrate sheets 51 having a relatively large diameter. In the description below of FIG. 7f, the differing configurations or alternative configurations are explained in more detail. With regard to the structurally identical or in principle structurally identical elements and parts according to the first embodiment, reference is made to the preceding figures.

FIG. 7f illustrates a diagrammatic sectional illustration along the line I-I according to FIG. 7e. The base plate 44 has a downwardly open cooling water groove 66 which is closed by a closure element 67, for example a disk, by means of a screw connection. The cooling medium is fed in and removed via cooling lines 86 (illustrated diagrammatically). An insulating layer 48 which has a clearance 131 is provided above the base plate 44. An aperture 151 is provided in the insulating layer 48 in order to feed in and remove the supply lines 91 for the heating elements 87.

In contrast to the first embodiment, the substrate sheet 51 is held down or fixed, preferably screwed, in the outer edge region by means of securing elements 161. This ensures that curvatures of the substrate sheet 51 are prevented. Reproducibility requirements are very exacting and lie, for example, in a region of less than 0.05 mm.

The substrate sheet 51 is positioned with respect to the heating plate 136 via a positioning pin 147 and a central mating element 139 and is positioned in said heating plate via the latching or spring element 143. Securing elements 161 are provided in the outer edge region and hold down the substrate sheet 51, with the result that the latter bears on the heating plate 136 in a flush or extensive manner. At an end facing the substrate sheet 51, the securing elements 161 have an external thread 162 and a hexagon socket receptacle 163. The securing elements 161 are held in a spring-mounted manner. After the substrate sheet 51 is placed on, the hexagon socket receptacle 163 is accessible via the hole 164, so that following this a screw connection can take place, as a result of which the substrate sheet 51 is held down with respect to the heating plate 136. This securing possibility is only by way of example. Further refinement possibilities for allowing a rapid installation and removal of the substrate sheet 51 permitting the substrate sheet 51 to bear in a planar manner with respect to the heating plate 136 during operation are likewise conceivable.

The cooling plate 132 is fixed with respect to the insulating layer 48 and with respect to the base plate 44 by a securing element 160 via a length compensation element 166. A cup spring assembly or the like can be provided as length compensation element 166 in order to allow a compensation due to the thermal change in length.

1. A substrate sheet for the application of at least one layer of a build-up material for the production of a three-dimensional molded body by successive consolidation of the layers of a pulverulent build-up material, which is consolidable by means of electromagnetic radiation or particle radiation, at the respective locations corresponding to a cross section of the molded body, which substrate sheet is releasably provided for positioning on a carrier in a process chamber, wherein a receiving section is provided which, on an upper side, has a receiving surface for receiving layers, and in that a supporting section is provided which, on a lower side, has a supporting surface facing the carrier, and comprises at least one depression which extends from the supporting surface of the supporting section at least toward the receiving section.

2. The substrate sheet as claimed in claim 1, wherein the receiving section is designed to be thinner than the supporting section.

3. The substrate sheet as claimed in claim 1, wherein a portion of the area of the supporting section which rests on the carrier is designed to be larger than the portion of the area of the depressions that faces the carrier.

4. The substrate sheet as claimed in claim 1, wherein the depressions have a rectangular, semicircular, wedge-shaped, trapezoidal or polygonal cross section.

5. The substrate sheet as claimed in claim 1, wherein the supporting section has depressions which run at least in a star-shaped manner with respect to its central point, are arranged concentrically with its central point, run in a rectilinear or curved manner, run parallel, intersect or are arranged in a checkerboard pattern.

6. The substrate sheet as claimed in claim 1, wherein the supporting section has a holding device which is provided for positioning and fixing the position of the supporting section on the carrier and is arranged in a position with respect to the supporting section that continues to be maintained irrespective of thermal expansions of the supporting section.

7. The substrate sheet as claimed in claim 1, wherein, in order to orient the position of the supporting section with respect to the carrier, an orientation element is provided which acts on a complementarily formed orientation element on the carrier.

8. The substrate sheet as claimed in 7, wherein the orientation element or the complementary orientation element is designed as a cutout in the shape of an elongated hole which is oriented as a function of the positioning of the holding device and of the thermal expansion behavior of the supporting section.

9. The substrate sheet as claimed in claim 7, wherein the supporting section being provided with a cutout or depression as orientation element, in which a positioning pin, which is arranged on the carrier, engages as a complementary orientation element.

10. The substrate sheet as claimed in claim 6, wherein the holding device is designed as a releasable connection which is held with respect to the carrier by a latching or spring element in a manner such that it can be exchanged.

11. The substrate sheet as claimed in claim 10, wherein the holding device comprises a locking bolt which is insertable into a mating element on the carrier.

12. The substrate sheet as claimed in claim 1, wherein securing elements act at least in the outer edge region of the receiving section and hold down the outer edge region of the supporting section with respect to the carrier.

13. The substrate sheet as claimed in claim 12, wherein the securing element is designed as a pull-down thread which is accessible from the upper side of the receiving section.

14. The substrate sheet as claimed in claim 12, wherein the securing elements are held in a spring-mounted manner in the carrier and the edge region of the supporting section is held down with respect to the carrier under spring force, the securing elements being arranged with radial play in the carrier.

15. The substrate sheet as claimed in claim 12, wherein the securing elements have a stem, the stems passing through the carrier and being actuable on a lower side of the carrier by an actuating device.

16. The substrate sheet as claimed in claim 12, wherein the securing elements hold down the supporting section with respect to the carrier by means of a rapid clamping device; or a helical groove clamping element.

17. The substrate sheet as claimed in claim 6, wherein the holding device is designed as a clamping element which passes through the carrier and is actuable on a lower side of the supporting section by an actuating device.

18. The substrate sheet as claimed in claim 17, wherein the clamping element is designed as a draw-in collet, a wing rod, a hollow conical stem or a threaded rod.

19. The substrate sheet as claimed in claim 9, wherein the orientation element or the complementary orientation element is designed as a cutout in the shape of an elongated hole which is oriented as a function of the positioning of the holding device and of the thermal expansion behavior of the supporting section.

20. The substrate sheet as claimed in claim 1, wherein the supporting section receives a holding device in the center of gravity of the area.

21. The substrate sheet as claimed in claim 11 wherein the mating element is arranged in a building platform of the carrier.
